(19) United States
(12) Patent Application Publication
(10) Pub. No.: US 2026/0192761 A1
(43) Pub. Date: Jul. 9, 2026

(54) WIRE HARNESS MANAGEMENT

(71) Applicant: Christopher Michael Bryant, Lagrange, GA (US)

(72) Inventor: Christopher Michael Bryant, Lagrange, GA (US)

(21) Appl. No.: 19/012,970

(22) Filed: Jan. 8, 2025

(51) Int. Cl. B60R 16/02; H01B 13/012

(52) U.S. Cl. CPC B60R 16/0215; H01B 13/01227

(57) ABSTRACT

A method and apparatus for wire harness management and positioning on a vehicle assembly line. A positioning platform is selectively extended to an operating position relative to a vehicle chassis. A wire harness assembly is oriented on the positioning platform to a desired position and then retained. After orientation and retention of the wire harness assembly on the positioning platform, the wire harness assembly is sequentially and efficiently attached to the vehicle chassis.

### TECHNICAL FIELD

The present disclosure is directed to the field of wire harnesses. More particularly, the present disclosure is directed to a method and apparatus for wire harness management and positioning during vehicle assembly.

### BACKGROUND

The electronic elements, inside a vehicle, present challenges with respect to managing the wire harnesses that connect them. A wire harness is designed to keep numerous wires or cables positioned together. The wires or cables and other components may be bound together with, for example, straps, sleeves, tape, or conduit.

A wire harness may have a tree-like structure, or trunk, consisting of a bundle of cables as well as attached components. The use of wire harnesses has grown in modern vehicles due to the increasing number of electronic devices installed for various functions.

Automobiles and other vehicles, such as trucks and buses, are demanding applications for the design of electrical systems. The electrical systems in these applications must operate well during a variety of environmental conditions, vibration, or other circumstances. The size and orientation of the trunk and branches of the wire harness can present a challenge when the wire harness is being attached within the chassis of a vehicle. Thus, there is a need for a method and apparatus for wire harness management and positioning during vehicle assembly.

### SUMMARY OF THE INVENTION

An object of this invention is to help reduce the chance of potential damage to the wiring harness during its attachment within the vehicle chassis. Another object of the invention is to make the attachment of the wire harness more efficient.

The foregoing objects of the invention are achieved by providing a movable positioning platform. The movable positioning platform is initially retracted to a rest position that is between a vehicle chassis and a movable support structure for the vehicle chassis. The positioning platform is selectively extended to an operating position when it is desired to manage or position a wire harness assembly into a desired orientation or configuration relative to the vehicle chassis. After the positioning platform is extended, the wire harness assembly is positioned, oriented into a desired configuration, and retained in the desired oriented position on the platform. This permits the sequential and efficient attachment of the wiring harness assembly to the vehicle chassis. Thereafter, the positioning platform may be retracted to its original rest position between the vehicle chassis and the support structure for the chassis.

There are advantages provided by the present method and apparatus for wire harness management and positioning during vehicle assembly. The method of using a unique movable positioning platform allows for orientation of the wiring harness assembly to permit its efficient attachment to the vehicle chassis. This and other features and advantages of the present invention will be better understood with reference to the following description and appended claims. The accompanying drawings, when combined with the written description, illustrate and describe the unique method and apparatus for wire harness management and positioning during vehicle assembly.

### BRIEF DESCRIPTION OF THE DRAWINGS

A full and enabling disclosure of the present method and apparatus, including the best mode thereof, directed to one of ordinary skill in the art, is set forth in the specification, which makes referance to the appended figures, in which:

FIG. 1 is a schematic illustration of the wire harness positioning platform, of the present invention, in an extended position.

FIG. 2 is a schematic illustration of a wire harness which has been positioned and oriented into a desired location on the wire harness positioning platform.

FIG. 3 is a schematic illustration of an operator maneuvering and installing the wire harness illustrated in FIG. 2.

FIG. 4 is a schematic illustration of the wire harness after it has been maneuvered and installed.

FIG. 5 illustrates the wire harness positioning platform in its retracted position.

FIG. 6 illustrates the wire harness positioning platform in its extended position.

### DETAILED DESCRIPTION

Reference will now be made to the method and apparatus for wire harness management and positioning that is illustrated in the drawings. It will be apparent to one of ordinary skill in the art that modifications can be made in the present invention without departing from the scope of the invention. Thus, it is intended that the present invention covers such modifications as fall within the scope of the appended claims and their equivalents.

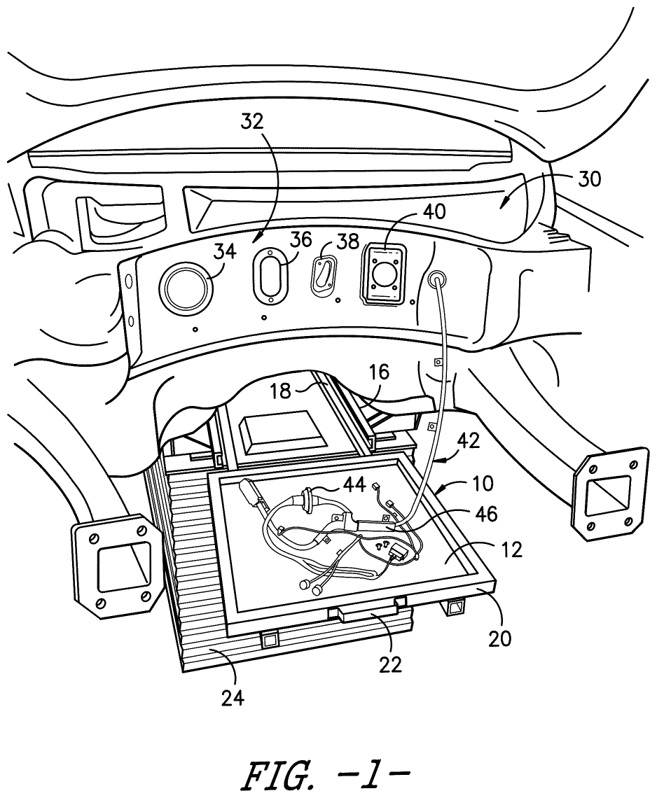

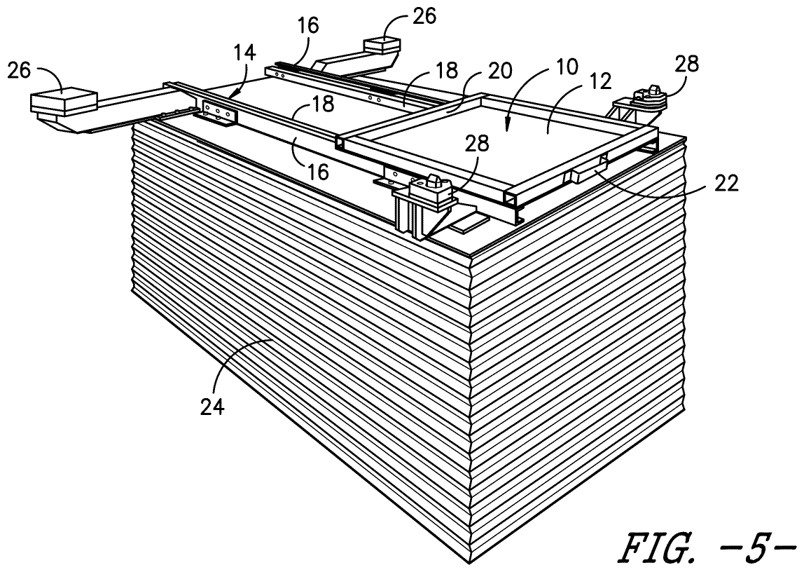

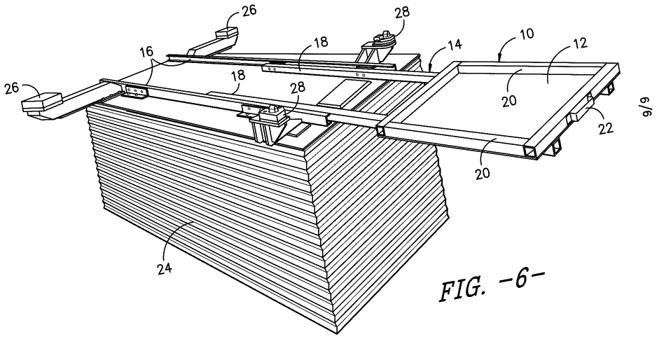

FIGS. 1-6 illustrate a method and apparatus for wire harness management and positioning during vehicle assembly. The method includes a movable positioning platform 10, which is best illustrated in FIGS. 5 and 6. Platform 10 is either in a retracted position, as shown in FIG. 5, or in an extended position as shown in FIG. 6.

Movable positioning platform 10 includes a staging surface 12, which is shaped and sized to allow for the positioning and orienting of a wire harness assembly, such as assembly 42.

The staging surface 12 is connected to a track and rail assembly 14, which includes tracks 16 and rails 18. When it is not in use, the staging surface 12 is retracted to a position that is shown in FIG. 5. During use of the staging surface 12, it is extended to a position such as illustrated in FIG. 6.

In addition to the staging surface 12, the movable positioning platform 10 also includes positional edges 20 and handle 22. Edges 20 are shaped and positioned to assist in the process step of orienting and positioning the desired wire harness assembly onto the positioning platform 10. Handle 22 may be used to position the platform 10 at a desired location relative to the chassis 30.

Referring to FIGS. 5 and 6, the positioning platform 10 and the assembly 14 are mounted to a movable support structure 24, which supports the vehicle chassis body 30. The support structure 24 includes support arms 26 and 28, which support a vehicle chassis body 30 during the assembly process. The movable positioning platform 10 is mounted in a location that is between the support structure 24 and the support arms 26 and 28 to allow the positioning platform 10 to be placed in a rest or retracted position that is located between the support structure 24 and the support arms 26 and 28, when it is not in use, and in an extended position, as shown in FIG. 6, when it is in use.

The rest and extended positions of the platform 10 are intended to provide efficiency and maneuverability to and for the operator in the process of attaching the wire harness assembly 42 to the vehicle chassis 30.

FIGS. 1-4 illustrate an example of a vehicle chassis 30 and engine compartment separation wall 32. FIGS. 1-4 also illustrate an example of the method and apparatus for wire harness management and positioning in accordance with the present invention.

The vehicle chassis 30 is built to sit on the support arms 26 and 28 of the movable support structure 24 as the support structure 24 is moved along an assembly or production line. The example wall 32 includes several openings 32, 34, 36, 38, and 40, which allow one or more wire harnesses, or portions thereof, to be maneuvered to and connected at other locations in the vehicle chassis 30.

The positioning platform 10 is retracted, as shown in FIG. 5, until it is desired to attach a wire harness assembly, such as assembly 42, into the vehicle chassis 30.

Then, the positioning platform 10 is extended to a desired location, such as shown in FIGS. 1 and 6, when it is desired to position a selected wire harness assembly, such as 42, into a desired attachment and orientation arrangement, which arrangement and orientation will allow for efficient and sequential positioning and installation of the wire harness assembly 42 on platform 10.

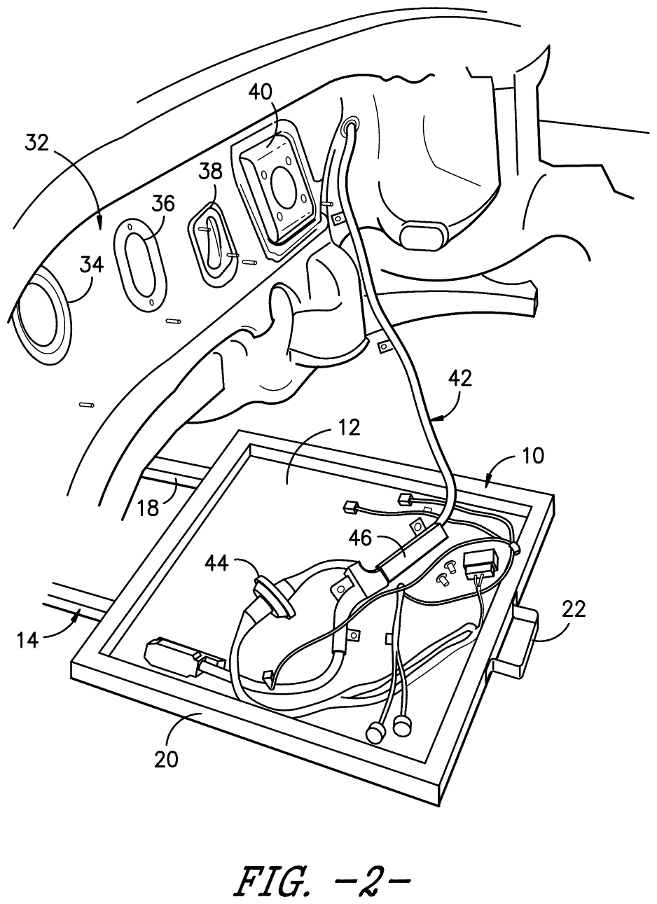

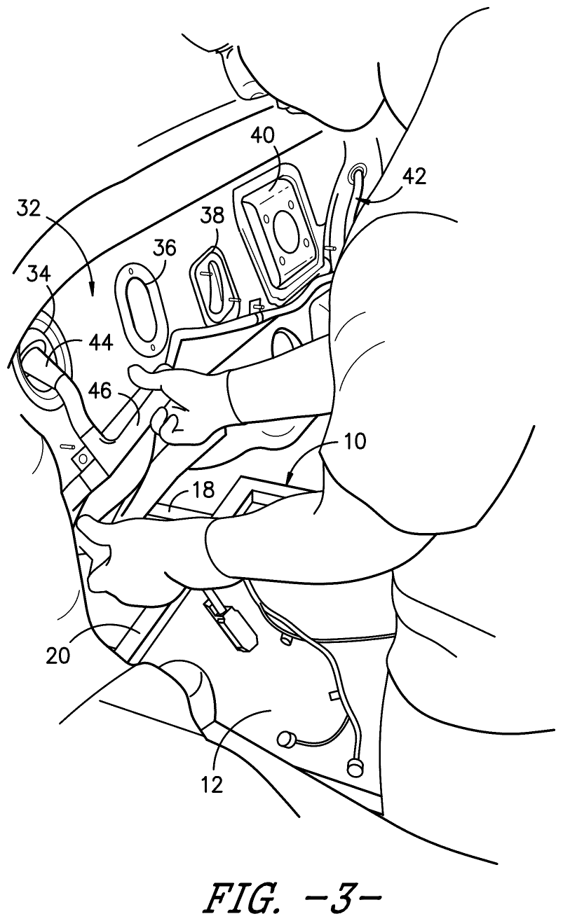

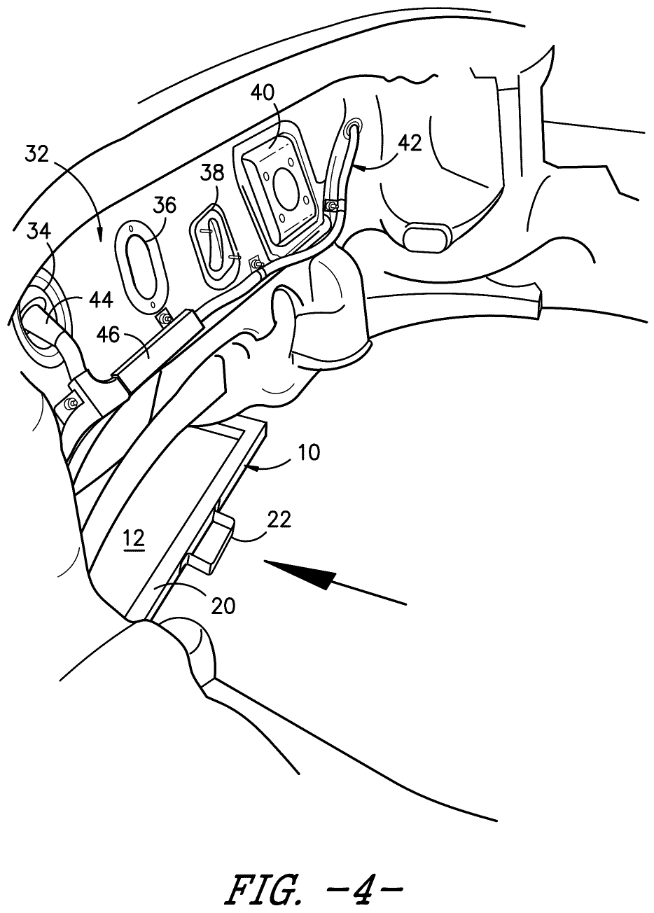

FIGS. 1 and 2 illustrate a desired orientation and attachment position of illustrated wire harness assembly 42 after the positioning platform 10 has been extended to its desired location. As shown, the wire harness assembly 42 is positioned and oriented into a desired location on the positioning platform 10. For example, components 44 and 46 are positioned to allow convenient and efficient movement and attachment of the components onto and through wall 32, as illustrated in FIGS. 3 and 4. Platform 10 retains the wire harness assembly 42 in a desired orientation to permit an operator to sequentially and efficiently attach the wire harness assembly 42 to the vehicle chassis 30, as shown in FIGS. 1-4.

Locating the movable positioning platform 10 between the vehicle chassis 30 and movable support structure 24 provides the preferred location of the platform 10 for utilization purposes. The platform 10 is stored in a location that allows it to be efficiently extended when needed. Further, the extension capability for the platform 10 allows it to be positioned at a desired location relative to the chassis 30, thereby providing an operator with assistance when attaching a wire harness assembly 42 to the vehicle chassis 30.

As described previously, after the positioning platform 10 is extended to the desired location, the wire harness assembly 42 is positioned and oriented into a desired configuration on the platform 10, as shown, for example, in FIGS. 1 and 2, so that it may be efficiently attached by the operator to the vehicle chassis 30. The positioning and orienting of the components of the wire harness assembly 42 is important since it allows for later sequential and efficient positioning and/or attachment of the assembly 42 to the chassis 30.

Since it is desired that the selected configuration of the wire harness assembly 42 be maintained before attachment to the chassis 30, the positioning platform 10 is configured to retain the wire harness assembly 42 in the selected configuration until it is attached or positioned on chassis 30.

The present invention may be embodied in other forms without departing from the spirit and the essential attributes thereof, and references should be made to the appended claims, and not just to the foregoing specification, as indicative of the scope of the invention.

What is claimed is:

1. A method for wire harness management for a vehicle chassis which is supported by a movable support structure, the method comprising the steps of: connecting a movable positioning platform to said movable support structure at a location that is between said vehicle chassis and said movable support structure; extending said movable positioning platform from a rest position to a desired operating position; moving a wire harness assembly onto said movable positioning platform; orienting said wire harness assembly into a desired orientation configuration of components; and sequentially attaching said wire harness assembly to said vehicle chassis in accordance with said desired orientation configuration of components.

2. The method of wire harness management according to claim 1 further comprising retracting said movable positioning platform to said rest position at a location between said vehicle chassis and said movable support structure.

3. The method of wire harness management according to claim 1 further comprising using said movable positioning platform for retaining said desired orientation configuration of components until sequentially attaching said wire harness assembly to said vehicle chassis.
